(19) United States
(12) Patent Application Publication
(10) Pub. No.: US 2025/0012588 A1
(43) Pub. Date: Jan. 9, 2025

(54) NAVIGATION SYSTEM

(71) Applicant: TOYOTA JIDOSHA KABUSHIKI KAISHA, Toyota-shi (JP)

(72) Inventors: Kazunori WATANABE, Okazaki-shi (JP); Taiki NAKAMURA, Kariya-shi (JP)

(73) Assignee: TOYOTA JIDOSHA KABUSHIKI KAISHA, Toyota-shi (JP)

(21) Appl. No.: 18/672,807

(22) Filed: May 23, 2024

(30) Foreign Application Priority Data
Jul. 6, 2023 (JP) 2023-111515

(51) Int. Cl. G01C 21/36; H04W 4/40; H04W 4/80

(52) U.S. Cl. CPC G01C 21/362; H04W 4/40; H04W 4/80

(57) ABSTRACT

When the second mobile terminal is brought close to the first mobile terminal, the installation information of the passenger application is transmitted to the second mobile terminal. When the installation is confirmed, the passenger application is installed. After that, when the operation of designating the destination is performed in the second mobile terminal, the destination information is transferred from the destination setting application to the passenger application. The user is guided to bring the second mobile terminal closer to the first mobile terminal. When the user brings the second mobile terminal closer to the first mobile terminal, destination information is transmitted from the second mobile terminal to the navigation device via the first mobile terminal. A destination is set in the navigation device.

### CROSS-REFERENCE TO RELATED APPLICATION

This application claims priority to Japanese Patent Application No. 2023-111515 filed on Jul. 6, 2023, incorporated herein by reference in its entirety.

### BACKGROUND

### 1. Technical Field

The present disclosure relates to a navigation system.

### 2. Description of Related Art

In a vehicle used in a transportation business such as a taxi, it is required to register a destination desired by a user in an in-vehicle navigation device. Therefore, for example, as described in Japanese Unexamined Patent Application Publication No. 2019-184336 (JP 2019-184336 A), a technique is known in which, by performing Near Field Communication (NFC) between an in-vehicle communication unit and a user's mobile terminal or the like, a destination of the in-vehicle navigation device is set using destination information held in the user's mobile terminal.

However, in order to enable communication between the in-vehicle navigation device and any mobile terminal, a complicated operation is required at the time of pairing, or a dedicated device for enabling communication by a simple operation is required to be provided in the navigation device.

### SUMMARY

The present disclosure has been made to solve the above-described problems. An object of the present disclosure is to provide a navigation system capable of registering information of a destination desired by a user with a simple operation.

A navigation system according to an aspect of the present disclosure includes:
a first mobile terminal;
a second mobile terminal that establishes communication with the first mobile terminal by short-range wireless communication, when a distance from the first mobile terminal becomes equal to or less than a predetermined value; and an in-vehicle navigation device that is able to communicate with the first mobile terminal.
   When the communication between the first mobile terminal and the second mobile terminal is established, the first mobile terminal receives destination information including a destination selected in the second mobile terminal, and transmits the destination information to the navigation device.
   When the navigation device receives the destination information from the first mobile terminal, the navigation device sets a destination of route guidance using the received destination information.

In this way, when the communication between the first mobile terminal and the second mobile terminal by short-range communication is established, the first mobile terminal and the navigation device can communicate with each other. Communication between the second mobile terminal and the navigation device is possible via the first mobile terminal without providing the navigation device with a dedicated device that enables direct communication with the second mobile terminal. Therefore, the destination selected in the second mobile terminal can be set as the destination of the route guidance in the navigation device.

In an embodiment, when the communication between the first mobile terminal and the second mobile terminal is established, the first mobile terminal transmits predetermined software to the second mobile terminal. The predetermined software includes software that enables the destination information to be transmitted to the first mobile terminal by the short-range wireless communication.

In this way, when the communication between the second mobile terminal and the first mobile terminal is established, the second mobile terminal can acquire the predetermined software by the short-range wireless communication. The destination information can be transmitted to the first mobile terminal.

Further, in an embodiment, the second mobile terminal converts information including the destination selected using existing software of the second mobile terminal into the destination information that is able to be transmitted to the first mobile terminal by the short-range wireless communication, by using the predetermined software.

In this way, the destination can be selected using the existing software of the second mobile terminal. It is possible to easily select a destination using software familiar to the user.

Further, in an embodiment, each of the first mobile terminal and the second mobile terminal is configured to be able to perform NFC-communication.

In this way, communication can be established between the first mobile terminal and the second mobile terminal by the NFC-communication.

According to the present disclosure, it is possible to provide a navigation system capable of registering information of a destination desired by the user with a simple operation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of a vehicle equipped with a navigation system according to the present embodiment;

FIG. 2 is a sequence diagram for explaining an example of an installation process of a passenger application executed in each of the first mobile terminal and the second mobile terminal;

FIG. 3 is a sequence diagram for describing an example of a process of generating destination information executed in the second mobile terminal;

FIG. 4 is a flowchart for explaining an exemplary process of transferring destination information executed in each of the navigation device, the first mobile terminal, and the second mobile terminal; and

FIG. 5 is a diagram for explaining an example of a series of operations performed by each of the navigation device, the first mobile terminal, and the second mobile terminal.

### DETAILED DESCRIPTION OF EMBODIMENTS

Hereinafter, an embodiment of the present disclosure will be described in detail with reference to the drawings. In the drawings, the same or corresponding portions are denoted by the same reference signs and the description thereof will not be repeated.

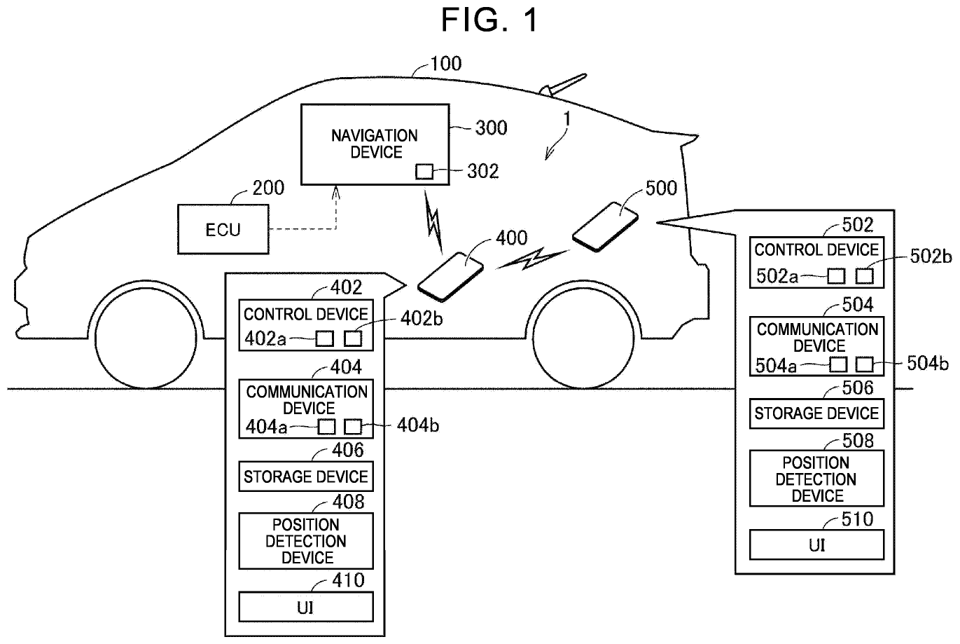

FIG. 1 is a diagram illustrating an example of a configuration of a vehicle 100 equipped with the navigation system 1 according to the present embodiment. The vehicle 100 according to the present embodiment includes, for example, a vehicle used as a taxi. As illustrated in FIG. 1, the vehicle 100 is equipped with a navigation system 1. The navigation system 1 includes an ECU 200, a navigation device 300, a first mobile terminal 400, and a second mobile terminal 500.

The ECU 200 is a computer having a processor executing programs such as Central Processing Unit (CPU), memories such as Read Only Memory (ROM) and Random Access Memory (RAM), and input/output interfaces. ECU 200 includes various control programs for controlling various electric apparatuses mounted on the vehicle 100. The various control programs further include, for example, a control program for controlling the operation of the navigation device 300 in addition to the control program for controlling the behavior of the vehicle 100. Note that the control subject that controls the operation of the navigation device 300 may be built in the navigation device 300 as a control unit.

The navigation device 300 sets the travel route to the destination using the information about the destination received from the user or the first mobile terminal 400. The navigation device 300 acquires the position of the vehicle 100 using a position detection device (not shown) such as a Global Positioning System (GPS). The navigation device 300 notifies the information about the route guidance using a notification device (a display device, a speaker, or the like) according to the set travel route.

The navigation device 300 includes a communication device 302. The communication device 302 is configured to be usable by, for example, a first communication method (for example, Bluetooth (registered trademark), Wi-Fi, or the like) that requires a process such as a pre-pairing with a device to be communicated. In the present embodiment, the first mobile terminal 400 is included as a device to be communicated. That is, the navigation device 300 and the first mobile terminal 400 are in a communicable state through authentication processing such as pairing.

The first mobile terminal 400 is a portable mobile terminal such as a smartphone, a tablet terminal, or a wearable device, and is carried by, for example, a driver of the vehicle 100.

The first mobile terminal 400 includes a control device 402, a communication device 404, a storage device 406, a position detection device 408, and a user interface (hereinafter referred to as UI) 410. The control device 402, the communication device 404, the storage device 406, the position detection device 408, and UI 410 are communicably connected to each other by a communication bus (not shown).

The control device 402 includes a processor 402a for executing a program such as a CPU and a memory 402b. A program (e.g., application software (hereinafter simply referred to as an application)) stored in a memory is read by a processor and software processing is executed. The application is started by executing the software processing. Various kinds of control by the control device 402 are not limited to software processing, and may be processed by dedicated hardware (electronic circuit).

The communication device 404 includes a first communication unit 404a that enables communication in a first communication format, and a second communication unit 404b that enables communication in a second communication format (for example, near field communication such as NFC communication). The communication device 404 enables NFC communication between the communication device 404 and another device capable of NFC communication when the distance between the second communication unit 404b and 20 the other device becomes equal to or smaller than a predetermined value.

The storage device 406 stores various types of information including information about an application. The storage device 406 stores, for example, information about an application to be transmitted to the second mobile terminal 500 when communication is performed with the second mobile terminal 500, which will be described later, by short-range wireless communication.

The position detection device 408 detects, for example, position information of the first mobile terminal 400. For example, the position detection device 408 detects the position of the first mobile terminal 400 using GPS satellites or wireless Local Area Network (LAN).

UI 410 includes, for example, a display device for displaying various types of information, and an input device (neither of which is shown) for accepting a user's manipulation. UI 410 may be constituted by, for example, a touch panel display.

The second mobile terminal 500 is a portable mobile terminal such as a smartphone, a tablet terminal, or a wearable device, and is carried by a user (hereinafter referred to as a passenger) of the vehicle 100 that is, for example, a taxi.

The second mobile terminal 500 includes a control device 502, a communication device 504, a storage device 506, a position detection device 508, and a UI 510. The control device 502, the communication device 504, the storage device 506, the position detection device 508, and UI 510 are communicably connected to each other by a communication bus (not shown). The control device 502 includes a processor 502a and a memory 502b. The communication device 504 includes a first communication unit 504a and a second communication unit 504b.

The control device 502, the communication device 504, the storage device 506, the position detection device 508, and UI 510 have the same configuration as the control device 402, the communication device 404, the storage device 406, the position detection device 408, and UI 410 of the first mobile terminal 400, respectively. Further, the processor 502a, the memory 502b, the first communication unit 504a, and the second communication unit 504b have the same configuration as the processor 402a, the memory 402b, the first communication unit 404a, and the second communication unit 404b, respectively. Therefore, detailed descriptions thereof will not be repeated.

When the vehicle 100 having the above-described configuration is used as a taxi, it is desirable that the destination designated by the passenger is registered in the navigation device 300 in order to properly arrive at the destination desired by the passenger. Therefore, when a passenger rides on the vehicle 100, it is required to quickly communicate with the navigation device 300 and transmit information about the destination.

However, in order to be able to communicate between the navigation device 300 and an arbitrary mobile terminal, a complicated operation such as inputting a password at the time of pairing is required, or a dedicated device for enabling communication with a simple operation is required to be provided in the navigation device 300.

Therefore, in the present embodiment, it is assumed that the first mobile terminal 400 and the navigation device 300 operate as follows. That is, when the distance between the first mobile terminal 400 and the second mobile terminal 500 becomes equal to or smaller than a predetermined value, communication by short-range wireless communication is established. At this time, when receiving the destination information including the destination selected by the second mobile terminal 500, the first mobile terminal 400 transmits the destination information to the navigation device 300. Upon receiving the destination information from the first mobile terminal 400, the navigation device 300 sets the destination of the route guidance using the received destination information.

In this way, communication between the first mobile terminal 400 and the second mobile terminal 500 is established by short-range communication. The first mobile terminal 400 and the navigation device 300 can communicate with each other. The navigation device 300 can communicate with the navigation device 300 via the first mobile terminal 400 with the second mobile terminal 500 without providing a dedicated device capable of directly communicating with the second mobile terminal 500. Therefore, the destination selected in the second mobile terminal 500 can be set as the destination for route guidance in the navigation device 300.

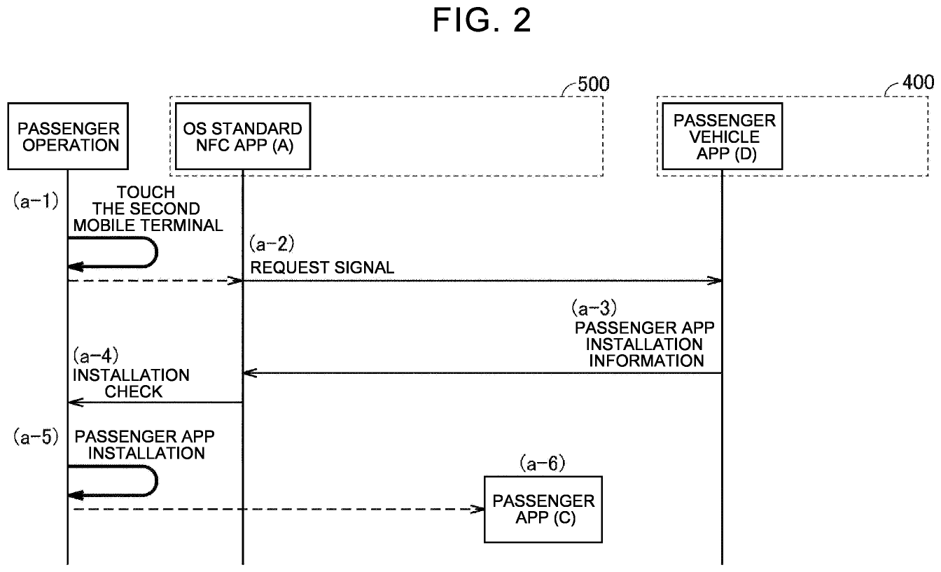

An example of a process of installing an application for a passenger executed in each of the first mobile terminal 400 and the second mobile terminal 500 will be described below with reference to FIG. 2. FIG. 2 is a sequence diagram for explaining an example of an installation process of the passenger application executed in each of the first mobile terminal 400 and the second mobile terminal 500.

As illustrated in FIG. 2, the first mobile terminal 400 includes a passenger vehicle application (D). Information about the passenger vehicle application (D) is stored in the storage device 406 of the first mobile terminal 400. Upon receiving an activation instruction of the passenger vehicle application (D), the control device 402 reads information about the passenger vehicle application (D) from the storage device 406 and executes a process of activating the passenger vehicle application (D). As described above, the process of activating the application is executed by the control device 402. The same applies to other applications, and therefore, the details thereof will not be repeated.

The passenger vehicle application (D) has, for example, a function of transmitting installation information of the passenger application (C) to a communication target in which communication by short-range wireless communication is enabled. The second mobile terminal 500 includes an application that transmits and receives information to and from a communication target through short-range wireless communication. As an application that transmits and receives data by short-range wireless communication, for example, an application (hereinafter, referred to as an NFC application (A)) that enables NFC communication mounted as a standard application of an Operating System (OS) of a mobile terminal is used. Functions of the passenger application (C) will be described later.

As illustrated in (a-1) of FIG. 2, the second mobile terminal 500 carried by the passenger is brought closer to the first mobile terminal 400 of the vehicle 100 until the distance is less than or equal to a predetermined value. Then, as illustrated in (a-2) of FIG. 2, communication by short-range radio communication is established, and a predetermined requesting signal is transmitted to the first mobile terminal 400. When the first mobile terminal 400 receives the predetermined request signal, as illustrated in (a-3) of FIG. 2, the installation information of the passenger application (C) stored in the storage device 406 is transmitted to the second mobile terminal 500.

As illustrated in (a-4) of FIG. 2, the second mobile terminal 500 confirms that the passenger application (C) is installed. For example, a message indicating whether the passenger application (C) may be installed in UI 510 of the second mobile terminal 500 is displayed. As illustrated in (a-5) of FIG. 2, when the passenger performs an operation of permitting installation (for example, a touch operation on a predetermined area) on UI 510, the control device 502 of the second mobile terminal 500 executes an installation process of the passenger application (C). Consequently, as shown in (a-6) of FIG. 2, the storage device 506 of the second mobile terminal 500 stores information about the passenger application (C). The passenger application (C) is ready to be executed.

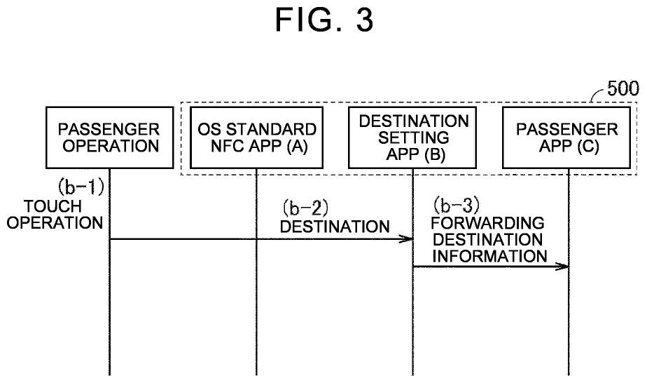

Hereinafter, an example of a process of generating destination information executed in the second mobile terminal 500 will be described with reference to FIG. 3. FIG. 3 is a sequence diagram for describing an example of a process of generating destination information executed in the second mobile terminal 500.

As illustrated in FIG. 3, the second mobile terminal 500 further includes, in addition to NFC application (A) and the passenger application (C) described above, an application (hereinafter, referred to as a destination setting application (B)) for setting a destination designated by the passenger.

The destination setting application (B) has a function of displaying map information on a display screen of UI 410 and a function of accepting an operation of designating a particular position in the displayed map image.

As illustrated in (b-1) of FIG. 3, for example, it is assumed that the passenger activates the destination setting application (B) and performs an operation (touch operation) of specifying a particular position in the map image displayed on the display screen. At this time, as illustrated in (b-2) of FIG. 3, the destination setting application (B) generates destination information including the position information by using the position designated by the touch operation as a destination. Note that the position information is information in which the position of the destination can be specified. The location information may include, for example, information about latitude and longitude of the destination. The location information may include information about a facility name whose destination is a location. Alternatively, the location information may include information about the address of the destination.

As illustrated in (b-3) of FIG. 3, the destination setting application (B) forwards the generated destination information to the passenger application. The destination setting application (B) may transfer the destination information to the passenger application (C) when receiving a predetermined operation of the passenger for transferring the destination information to the passenger application (C).

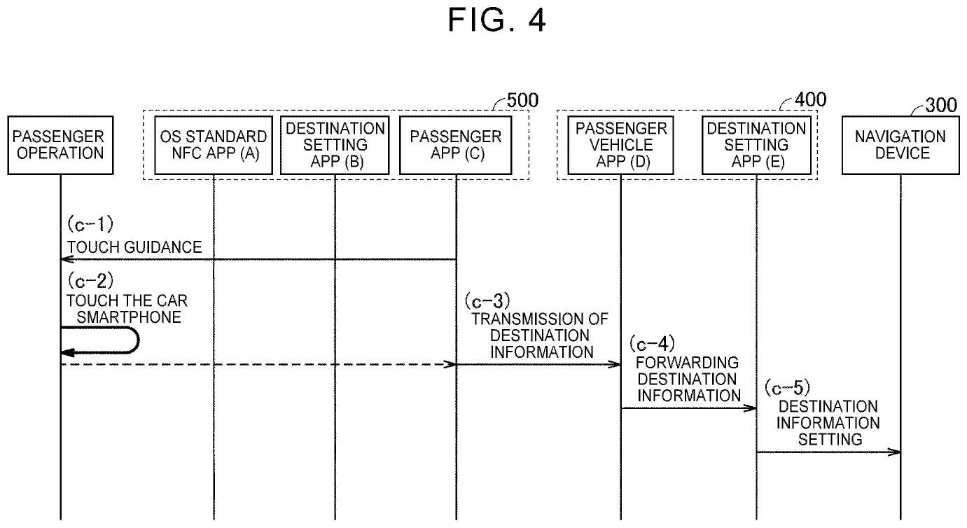

Hereinafter, an example of a process of transferring destination information executed in each of the navigation device 300, the first mobile terminal 400, and the second mobile terminal 500 will be described with reference to FIG. 4. FIG. 4 is a sequence diagram for describing an example of a process of transferring destination information executed in each of the navigation device 300, the first mobile terminal 400, and the second mobile terminal 500.

As illustrated in FIG. 4, the first mobile terminal 400 further includes an application (hereinafter, referred to as a destination setting application (E)) for setting a destination to be transmitted to the navigation device 300, in addition to the above-described passenger vehicle application (D).

As illustrated in (c-1) of FIG. 4, when the destination information is acquired, the passenger application (C) displays information for guiding the second mobile terminal 500 to approach the first mobile terminal 400 on UI 510 display screen.

As illustrated in (c-2) of FIG. 4, the passenger brings the second mobile terminal 500 closer to the first mobile terminal 400 until the distance is less than or equal to a predetermined value. Then, communication is established by short-range wireless communication. As illustrated in (c-3) of FIG. 4, the passenger application (C) transmits the destination information to the first mobile terminal 400.

As illustrated in (c-4) of FIG. 4, the passenger vehicle application (D) converts the received destination information into a format readable by a destination setting application (E) to be described later, and forwards the format to the destination setting application (E).

As illustrated in (c-5) of FIG. 4, the destination setting application (E) converts the destination information into a format that can be transmitted to the navigation device 300 that is capable of communication, and transmits the converted destination information to the navigation device 300. In the navigation device 300, a destination is set using the received destination information.

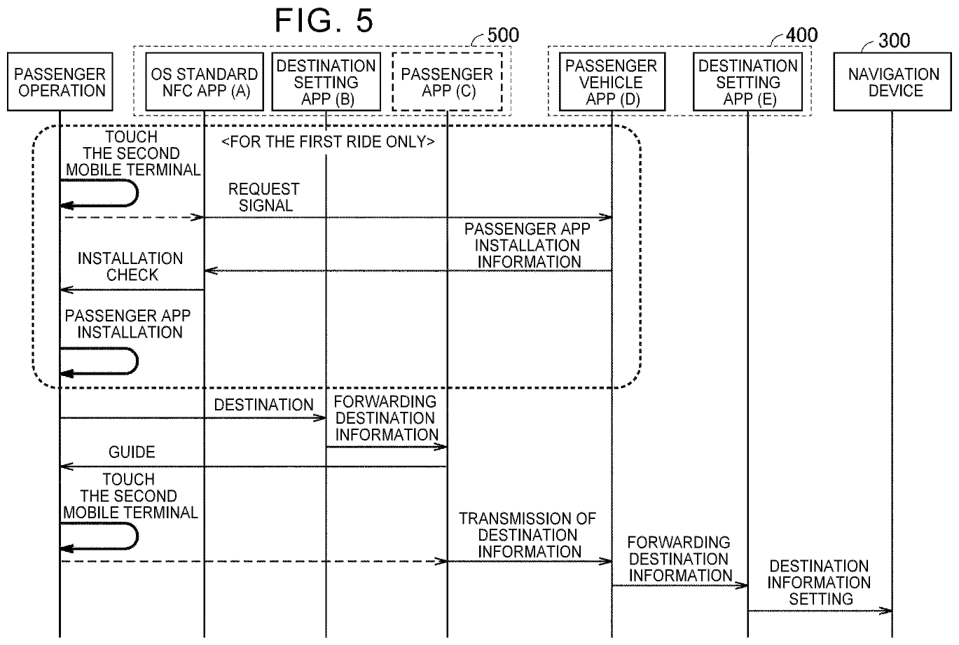

An example of a series of operations performed by the navigation device 300, the first mobile terminal 400, and the second mobile terminal 500 based on the configuration and the sequence diagram of the navigation system 1 as described above will be described with reference to FIG. 5. FIG. 5 is a diagram for explaining an example of a series of operations performed by each of the navigation device 300, the first mobile terminal 400, and the second mobile terminal 500.

The vehicle 100 is, for example, a taxi. The first mobile terminal 400 is installed at a predetermined position in the vehicle (for example, a position at which a passenger seated in the rear seat can bring the second mobile terminal 500 closer). The first mobile terminal 400 is in a state in which communication with the navigation device 300 is possible by a prior operation by the driver of the vehicle 100. For the passenger, the first boarding of the vehicle 100 equipped with the navigation system 1 is performed.

For example, when the passenger is seated in the rear seat of the taxi, the driver is prompted, or the passenger is prompted by a guide plate, voice guidance, or the like around the seated seat, thereby bringing the second mobile terminal 500 closer to the first mobile terminal 400. When the distance between the first mobile terminal 400 and the second mobile terminal 500 becomes equal to or smaller than a predetermined value capable of short-range wireless communication, NFC application (A) of the second mobile terminal 500 transmits a request-signal to the first mobile terminal 400. Upon receiving the request signal, the passenger vehicle application (D) of the first mobile terminal 400 transmits the installation information of the passenger application (C) to the second mobile terminal 500. In the second mobile terminal 500, a confirmation window for confirming whether or not to install is displayed on UI 510. When the user accepts an operation to permit the installation, the passenger application (C) is installed in the second mobile terminal 500. In this way, the processing at the time of the first boarding is executed.

After the processing at the time of the first boarding is executed, the passenger activates the destination setting application (B) of the second mobile terminal 500 and performs an operation of designating a desired destination. Then, the destination information is transferred from the destination setting application (B) to the passenger application (C).

When the destination information is transferred from the destination setting application (B) to the passenger application (C), an image or text information for guiding the passenger to approach the first mobile terminal 400 is displayed on UI 510 of the second mobile terminal 500. Note that the passenger application (C) may perform voice guidance so as to bring the second mobile terminal 500 closer to the first mobile terminal 400.

When the second mobile terminal 500 is brought close to the first mobile terminal 400, the passenger application (C) transmits destination information to the first mobile terminal 400. When the passenger vehicle application (D) of the first mobile terminal 400 receives the destination information, it is transferred to the destination setting application (E).

In the destination setting application (E), the destination information is converted into a format in which the destination can be set in the navigation device 300, and is transmitted to the navigation device 300. The destination is set using the destination information received by the navigation device 300.

As described above, according to the navigation system 1 of the present embodiment, communication between the first mobile terminal 400 and the second mobile terminal 500 by short-range communication is established. Communication between the first mobile terminal 400 and the navigation device 300 is possible. The navigation device 300 can communicate between the second mobile terminal 500 and the navigation device 300 via the first mobile terminal 400 without providing a dedicated device capable of directly communicating with the second mobile terminal 500. Therefore, the destination selected in the second mobile terminal 500 can be set as the destination of the route guidance in the navigation device 300. Therefore, it is possible to provide a navigation system capable of registering information of a destination desired by a user with a simple operation.

Further, the destination setting application (B) and the passenger application (C) are separately configured in the second mobile terminal 500. As the destination setting application (B), in OS, a conventional map application such as a standard map application or a map application which is generally widely used can be used. It is possible to improve convenience for passengers and to suppress an increase in cost for development of an application and the like.

Further, in the first mobile terminal 400, the passenger vehicle application (D) and the destination setting application (E) are separately configured. As the destination setting application (E), an existing application for transmitting destination information to the navigation device 300 can be used. It is possible to suppress an increase in cost for development of an application or the like.

Hereinafter, modifications will be described.

In the above-described embodiment, a case has been described as an example in which destination information including information about a destination designated in the second mobile terminal 500 is transmitted to the navigation device 300 via the first mobile terminal 400, and the destination is set in the navigation device 300. The destination information may include information about the travel route in addition to the information about the destination, and the travel route may be set in addition to the destination in the navigation device 300. Alternatively, information about a destination may be included in addition to the destination, and a destination may be set in the navigation device 300 in addition to the destination. In this way, the vehicle 100 can be moved to the destination on the travel route desired by the passenger.

Further, in the above-described embodiment, the passenger vehicle application (D) and the destination setting application (E) of the first mobile terminal 400 are separately configured, but the passenger vehicle application (D) and the destination setting application (E) may be configured by one application. By being configured as one application, it is possible to improve convenience for the driver.

Further, in the above-described embodiment, the case where the second mobile terminal 500 acquires the passenger application (C) from the first mobile terminal 400 has been described as an example, but it is not particularly limited to acquisition from the first mobile terminal 400. For example, the second mobile terminal 500 may acquire the passenger application (C) from a predetermined server via a communication line such as the Internet.

In addition, the above-mentioned modifications may be carried out by appropriately combining all or a part thereof.

The embodiments disclosed herein are illustrative in all respects and are not restrictive. The scope of the present disclosure is defined by the terms of the claims, rather than the description above, and includes any modifications within the scope and meaning equivalent to the terms of the claims.

What is claimed is:

1. A navigation system comprising:
a first mobile terminal;
a second mobile terminal that establishes communication with the first mobile terminal by short-range wireless communication, when a distance from the first mobile terminal becomes equal to or less than a predetermined value; and
an in-vehicle navigation device that is able to communicate with the first mobile terminal, wherein:
when the communication between the first mobile terminal and the second mobile terminal is established, the first mobile terminal receives destination information including a destination selected in the second mobile terminal, and transmits the destination information to the navigation device; and
when the navigation device receives the destination information from the first mobile terminal, the navigation device sets a destination of route guidance using the received destination information.

2. The navigation system according to claim 1, wherein:
when the communication between the first mobile terminal and the second mobile terminal is established, the first mobile terminal transmits predetermined software to the second mobile terminal; and
the predetermined software includes software that enables the destination information to be transmitted to the first mobile terminal by the short-range wireless communication.

3. The navigation system according to claim 2, wherein the second mobile terminal converts information including the destination selected using existing software of the second mobile terminal into the destination information that is able to be transmitted to the first mobile terminal by the short-range wireless communication, by using the predetermined software.

4. The navigation system according to claim 1, wherein each of the first mobile terminal and the second mobile terminal is configured to be able to perform near field communication-communication.
